(19) United States
(12) Patent Application Publication
(10) Pub. No.: US 2018/0319964 A1
(43) Pub. Date: Nov. 8, 2018

(54) Polyethylene Shrink Films and Processes for Making the Same

(71) Applicant: ExxonMobil Chemical Patents Inc., Baytown, TX (US)

(72) Inventors: Stefan B. OHLSSON, Keerbergen (BE); Wen LI, Houston, TX (US); Etienne R.H. LERNOUX, Longueville (BE); Jianya CHENG, Kingwood, TX (US); Xiao-Chuan WANG, Shanghai (CN)

(21) Appl. No.: 15/775,641

(22) PCT Filed: Dec. 20, 2016
(86) PCT No.: PCT/US2016/067721

§ 371 Date: May 11, 2018

Related U.S. Application Data
(60) Provisional application No. 62/293,553, filed on Feb. 10, 2016.

(30) Foreign Application Priority Data
Apr. 13, 2016 (EP) 16165124.5

(51) Int. Cl. C08L 23/08; C08J 5/18; B29C 47/00; B29C 47/06; B32B 27/08; B32B 27/32

(52) U.S. Cl. CPC C08L 23/0815; B29K 2023/0633; B29C 47/0004; B29C 47/0021; B29C 47/0026; B29C 47/0057; B29C 47/065; B32B 27/08; B32B 27/32; C08L 2203/16; C08L 2205/025; C08L 2207/066; C08J 2323/08; C08J 2423/06; C08J 5/18

(57) ABSTRACT

Shrink films made from metallocene-catalyzed polyethylene polymers and processes for making the same are disclosed.

### CROSS-REFERENCE OF RELATED APPLICATIONS

This application claims the benefit of Provisional Application No. 62/293,553, filed Feb. 10, 2016 and European Application No. 16165124.5, filed Apr. 13, 2016, both of which are incorporated by reference. This application also relates to “Polyethylene Films and Processes for Making Them,” filed concurrently herewith, Attorney Docket No. 2016EM016, U.S. Ser. No. 62/293,559, filed Feb. 10, 2016, the contents of which are incorporated by reference.

### FIELD OF THE INVENTION

The present invention generally relates to shrink films made from metallocene-catalyzed polyethylene polymers.

### BACKGROUND OF THE INVENTION

Shrink films are polymer films which on application of typically heat shrink in one or both directions. They generally are categorized into industrial shrink films and retail shrink films and widely used as packaging and casing materials for both large and small products (e.g., industrial pallets, bottles, magazines, toys, etc.). In particular, they may further be categorized as display shrink film having a typical film thickness of 15-20 μm made using double bubble technology (discussed more below), collation shrink film for bundling of articles to form multipacks having a typical film thickness of 35-80 μm made on conventional single bubble blown film equipment, and industrial shrink film (hood) for securing products/articles on a pallet for transportation having a typical film thickness of 80-160 μm made from a similar process to collation shrink film but using larger equipment.

As referred to above, industrial shrink films are commonly used for bundling articles on pallets. Typical industrial shrink films are formed in a single bubble blown extrusion process and may include orientation in the machine direction (MD) and transverse direction (TD). The main structural component of such industrial shrink films is typically high pressure, low density polyethylene (LDPE), often blended with up to about 30 weight percent of linear low density polyethylene (LLDPE) to reduce problems of hole formation during shrinkage. Such films are typically formed in a single bubble blown extrusion process and may include orientation in the machine direction and transverse direction.

Retail shrink films are commonly used for packaging and/or bundling articles for consumer use, such as, for example, in supermarket goods, consumer products, and toys. Among them, soft shrink or low shrink force films are now more and more required to pack thin and easy to distort items such as stationaries, magazines, and paper products. The film requires high shrink percentage in both machine direction (MD) and transverse direction (TD) but low shrink tension or contracting force to prevent fragile contents from being crushed by the contracting force while wrapping the products.

A conventional approach to soft shrink film is through double bubble processes to provide additional transverse direction stretch to the film. Such processes form the film in two successive bubbles, with an intermediate heating step between the two bubbles. In this way, bi-axial orientation can be achieved imparting isotropic properties to the final film product in the machine and transverse direction. Additionally, some film products are crosslinked for improved mechanical properties. Unfortunately, such processes are complex, energy demanding, costly, and the specialized equipment requires a significant capital investment. Additionally, commercially available polyethylene resins used for shrink film cannot make shrink films with thicknesses less than 35 μm without creating “draw-down” problems, lacking suitable shrink properties like having machine direction shrink only, and/or generally having low shrinkage ill-suited for the desired application. Thus, a film of 20-35 μm having suitable shrink properties and addressing these challenges is very desirable. It would also be very desirable to not have to resort to double bubble technology for reasons previously explained. In addition, ideal processes that would provide for tailoring the shrink force towards lower forces for fragile goods and articles would also be desirable.

Special families of polymers such as metallocene polyethylene (mPE) resins available from ExxonMobil Chemical Company, Houston, Tex., show much promise for shrink film applications. Metallocene PE provides for a good balance of operational stability, extended output, versatility with higher alpha olefin (HAO) performance, and resin sourcing simplicity. In particular, Ser. No. 62/082,896, filed Nov. 21, 2014, discloses a metallocene polyethylene resin having a melt index (I_{2.16}) of 0.2 g/10 min and a density of 0.916 g/cm³ incorporated in a multi-layer film. (See the Examples). It is found that these resins can be used to produce soft shrink film through single bubble extrusion process that meets requirements such as high TD shrink, high total shrink, low shrink tension, and good mechanical and optical properties. See also, Ser. No. 62/219,846, filed Sep. 17, 2015. For example, mPE has been very successful penetrating the collation shrink and industrial shrink markets for products where high holding force is required. Nevertheless, certain applications still require further improvements where high shrink and low (tailored) shrink force are required for light weight or fragile products sensitive to corner deformation.

Thus, there is a long felt need to have shrink film with a combination of high TD shrinkability and low contracting force or holding tension as well as good optical and mechanical properties, without having to resort to a complex process such as the double bubble extrusion process.

### SUMMARY OF THE INVENTION

In a class of embodiments, the invention provides for a shrink film comprising: a polyethylene polymer comprising at least 65 wt % ethylene derived units, based upon the total weight of the polymer, having:
a. a melt index (MI) from about 0.1 g/10 min to about 2.0 g/10 min;
b. a density from about 0.905 g/cm³ to about 0.920 g/cm³; and
c. a melt index ratio (MIR) from about 25 to about 80;

wherein the shrink film has a total shrink of from 100% to 200%.

In another class of embodiments, the invention provides for a process to produce a shrink film, the process comprising: a) extruding a polyethylene polymer comprising at least 65 wt % ethylene derived units, based upon the total weight of the polymer, having: i. a melt index (MI) from about 0.1 g/10 min to about 2.0 g/10 min; ii. a density from about 0.905 g/cm³ to about 0.920 g/cm³; and iii. a melt index ratio (MIR) from about 25 to about 80; to produce a molten material; and b) blowing the molten material to produce a bubble to produce the shrink film having a total shrink of from 100% to 200%.

Other embodiments of the invention are described and claimed herein and are apparent by the following disclosure.

### DETAILED DESCRIPTION OF ILLUSTRATIVE EMBODIMENTS

Before the present polymers, compounds, components, compositions, and/or methods are disclosed and described, it is to be understood that unless otherwise indicated this invention is not limited to specific polymers, compounds, components, compositions, reactants, reaction conditions, ligands, metallocene structures, or the like, as such may vary, unless otherwise specified. It is also to be understood that the terminology used herein is for the purpose of describing particular embodiments only and is not intended to be limiting.

It must also be noted that, as used in the specification and the appended claims, the singular forms “a,” “an” and “the” include plural referents unless otherwise specified.

### Definitions

For the purposes of this disclosure, the following definitions will apply, unless otherwise stated:

Molecular weight distribution (“MWD”) is equivalent to the expression M_{w}/Mₙ. The expression M_{w}/Mₙ, is the ratio of the weight average molecular weight (M_{w}) to the number average molecular weight (Mₙ). The weight average molecular weight is given by

$${M}_{w} = \frac{{\sum }_{i} {n}_{i} {M}_{i}^{2}}{{\sum }_{i} {n}_{i} {M}_{i}}$$

The number average molecular weight is given by

$${M}_{n} = \frac{{\sum }_{i} {n}_{i} {M}_{i}}{{\sum }_{i} {n}_{i}}$$

The z-average molecular weight is given by

$${M}_{z} = \frac{{\sum }_{i} {n}_{i} {M}_{i}^{3}}{{\sum }_{i} {n}_{i} {M}_{i}^{2}}$$

where nᵢ in the foregoing equations is the number fraction of molecules of molecular weight Mᵢ. Measurements of M_{w}, M_{z}, and Mₙ, are typically determined by Gel Permeation Chromatography as disclosed in Macromolecules, Vol. 34, No. 19, Effect of Short Chain Branching on the Coil Dimensions of Polyolefins in Dilute Solution, Sun et al., pg. 6812-6820 (2001). This method is the preferred method of measurement and used in the examples and throughout the disclosures unless otherwise specified.

The broadness of the composition distribution of the polymer may be characterized by T₇₅-T₂₅ It is readily determined utilizing well known techniques for isolating individual fractions of a sample of the copolymer. One such technique is Temperature Rising Elution Fraction (TREF), as described in Wild, J. Poly. Sci., Poly. Phys. Ed., Vol. 20, pg. 441 (1982) and U.S. Pat. No. 5,008,204. For example, TREF may be measured using an analytical size TREF instrument (Polymerchar, Spain), with a column of the following dimensions: inner diameter (ID) 7.8 mm, outer diameter (OD) 9.53 mm, and column length of 150 mm The column may be filled with steel beads. 0.5 mL of a 4 mg/ml polymer solution in orthodichlorobenzene (ODCB) containing 2 g BHT/4 L were charge onto the column and cooled from 140° C. to −15° C. at a constant cooling rate of 1.0° C./min Subsequently, ODCB may be pumped through the column at a flow rate of 1.0 ml/min, and the column temperature may be increased at a constant heating rate of 2° C./min to elute the polymer. The polymer concentration in the eluted liquid may then be detected by means of measuring the absorption at a wavenumber of 2941 cm⁻¹ using an infrared detector. The concentration of the ethylene-α-olefin copolymer in the eluted liquid may be calculated from the absorption and plotted as a function of temperature. As used herein, T₇₅-T₂₅ values refer to where T₂₅ is the temperature in degrees Celsius at which 25% of the eluted polymer is obtained and T₇₅ is the temperature in degrees Celsius at which 75% of the eluted polymer is obtained via a TREF analysis. For example, in an embodiment, the polymer may have a T₇₅-T₂₅ value from 5 to 10, alternatively, a T₇₅-T₂₅ value from 5.5 to 10, and alternatively, a T₇₅-T₂₅ value from 5.5 to 8, alternatively, a T₇₅-T₂₅ value from 6 to 10, and alternatively, a T₇₅-T₂₅ value from 6 to 8, where T₂₅ is the temperature in degrees Celsius at which 25% of the eluted polymer is obtained and T₇₅ is the temperature in degrees Celsius at which 75% of the eluted polymer is obtained via temperature rising elution fractionation (TREF).

Additional definitions that will better help the reader understand the claimed invention are provided below.

### Polyethylene Polymer

The polyethylene polymers are ethylene-based polymers having about 99.0 to about 80.0 wt %, 99.0 to 85.0 wt %, 99.0 to 87.5 wt %, 99.0 to 90.0 wt %, 99.0 to 92.5 wt %, 99.0 to 95.0 wt %, or 99.0 to 97.0 wt %, of polymer units derived from ethylene and about 1.0 to about 20.0 wt %, 1.0 to 15.0 wt %, 1.0 to 12.5 wt %, 1.0 to 10.0 wt %, 1.0 to 7.5 wt %, 1.0 to 5.0 wt %, or 1.0 to 3.0 wt % of polymer units derived from one or more C₃ to C₂₀ α-olefin comonomers, preferably C₃ to C₁₀ α-olefins, and more preferably C₄ to C₈ α-olefins. The α-olefin comonomer may be linear, branched, cyclic and/or substituted, and two or more comonomers may be used, if desired. Examples of suitable comonomers include propylene, butene, 1-pentene; 1-pentene with one or more methyl, ethyl, or propyl substituents; 1-hexene; 1-hexene with one or more methyl, ethyl, or propyl substituents; 1-heptene; 1-heptene with one or more methyl, ethyl, or propyl substituents; 1-octene; 1-octene with one or more methyl, ethyl, or propyl substituents; 1-nonene; 1-nonene with one or more methyl, ethyl, or propyl substituents; ethyl, methyl, or dimethyl-substituted 1-decene; 1-dodecene; and styrene. Particularly suitable comonomers include 1-butene, 1-hexene, and 1-octene, 1-hexene, and mixtures thereof.

In an embodiment of the invention, the polymer comprises from about 8 wt % to about 15 wt %, of C₃-C₁₀ α-olefin derived units, and from about 92 wt % to about 85 wt % ethylene derived units, based upon the total weight of the polymer.

In another embodiment of the invention, the polymer comprises from about 9 wt % to about 12 wt %, of C₃-C₁₀ α-olefin derived units, and from about 91 wt % to about 88 wt % ethylene derived units, based upon the total weight of the polymer.

The polyethylene polymers may have a melt index (MI), I_{2.16} or simply 12 for shorthand according to ASTM D1238, condition E (190° C./2.16 kg) reported in grams per 10 minutes (g/10 min), of ≥about 0.10 g/10 min., e.g., ≥about 0.15 g/10 min., ≥about 0.18 g/10 min., ≥about 0.20 g/10 min., ≥about 0.22 g/10 min., ≥about 0.25 g/10 min., or ≥about 0.28 g/10 min. Additionally, the polyethylene polymers may have a melt index (I_{2.16}) ≤about 2.0 g/10 min., e.g., ≤about 1.5 g/10 min., ≤about 1.0 g/10 min., ≤about 0.75 g/10 min., ≤about 0.50 g/10 min., ≤about 0.30 g/10 min., ≤about 0.25 g/10 min., ≤about 0.22 g/10 min., ≤about 0.20 g/10 min., ≤about 0.18 g/10 min., or ≤about 0.15 g/10 min. Ranges expressly disclosed include, but are not limited to, ranges formed by combinations any of the above-enumerated values, e.g., from about 0.1 to about 2.0, about 0.2 to about 1.0, about 0.2 to about 0.5 g/10 min. etc.

The polyethylene polymers may also have High Load Melt Index (HLMI), I_{21.6} or I₂₁ for shorthand, measured in accordance with ASTM D-1238, condition F (190° C./21.6 kg). For a given polymer having an MI and MIR as defined herein, the HLMI is fixed and can be calculated in accordance with the following paragraph.

The polyethylene polymers may have a Melt Index Ratio (MIR) which is a dimensionless number and is the ratio of the high load melt index to the melt index, or I_{21.6}/I_{2.16} as described above. The MIR of the polyethylene polymers may be from 25 to 80, alternatively, from 25 to 60, alternatively, from about 30 to about 55, and alternatively, from about 35 to about 50.

The polyethylene polymers may have a density ≥about 0.905 g/cm³, ≥about 0.910 g/cm³, ≥about 0.912 g/cm³, ≥about 0.913 g/cm³, ≥about 0.915 g/cm³, ≥about 0.916 g/cm³, ≥about 0.917 g/cm³, ≥about 0.918 g/cm³. Additionally or alternatively, polyethylene polymers may have a density ≤about 0.920 g/cm³, e.g., ≤about 0.918 g/cm³, ≤about 0.917 g/cm³, ≤about 0.916 g/cm³, ≤about 0.915 g/cm³, or ≤about 0.914 g/cm³. Ranges expressly disclosed include, but are not limited to, ranges formed by combinations any of the above-enumerated values, e.g., from about 0.905 to about 0.920 g/cm³, 0.910 to about 0.920 g/cm³, 0.915 to 0.920 g/cm3, 0.914 to 0.918 g/cm3, 0.915 to 0.917 g/cm3, etc. Density is determined using chips cut from plaques compression molded in accordance with ASTM D-1928 Procedure C, aged in accordance with ASTM D-618 Procedure A, and measured as specified by ASTM D-1505.

Typically, although not necessarily, the polyethylene polymers may have a molecular weight distribution (MWD, defined as Kan) of about 2.5 to about 5.5, preferably 3.0 to 4.0.

The melt strength of a polymer at a particular temperature may be determined with a Gottfert Rheotens Melt Strength Apparatus. To determine the melt strength, a polymer melt strand extruded from the capillary die is gripped between two counter-rotating wheels on the apparatus. The take-up speed is increased at a constant acceleration of 2.4 mm/sec². The maximum pulling force (in the unit of cN) achieved before the strand breaks or starts to show draw-resonance is determined as the melt strength. The temperature of the rheometer is set at 190° C. The capillary die has a length of 30 mm and a diameter of 2 mm. The polymer melt is extruded from the die at a speed of 10 mm/sec. The distance between the die exit and the wheel contact point should be 122 mm The melt strength of polymers of embodiments of invention may be in the range from about 1 to about 100 cN, about 1 to about 50 cN, about 1 to about 25 cN, about 3 to about 15 cN, about 4 to about 12 cN, or about 5 to about 10 cN.

The polyethylene polymers (or films made therefrom) may also be characterized by an averaged 1% secant modulus (M) of from 10,000 to 60,000 psi (pounds per square inch), alternatively, from 20,000 to 40,000 psi, alternatively, from 20,000 to 35,000 psi, alternatively, from 25,000 to 35,000 psi, and alternatively, from 28,000 to 33,000 psi, and a relation between M and the dart drop impact strength in g/mil (DIS) complying with formula (A):

DIS≥0.8*[100+e^{(11.71-0.000268M+2.183×10}^{^{−9}}^{M}^{²}⁾], (A)

where “e” represents 2.7183, the base Napierian logarithm, M is the averaged modulus in psi, and DIS is the 26 inch dart impact strength. The DIS is preferably from about 120 to about 1000 g/mil, even more preferably, from about 150 to about 800 g/mil.

The relationship of the Dart Impact Strength to the averaged 1% secant modulus is thought to be one indicator of long-chain branching in the ethylene-based polymer. Thus, alternatively ethylene-based polymers of certain embodiments may be characterized as having long-chain branches. Long-chain branches for the purposes of this invention represent the branches formed by reincorporation of vinyl-terminated macromers, not the branches formed by incorporation of the comonomers. The number of carbon atoms on the long-chain branches ranges from a chain length of at least one carbon more than two carbons less than the total number of carbons in the comonomer to several thousands. For example, a long-chain branch of an ethylene/hexene ethylene-based polymer may have chain comprising greater than 6 carbon atoms, greater than 8 carbon atoms, greater than 10 carbon atoms, greater than 12 carbon atoms, etc. and combinations thereof for long-chain branches.

Various methods are known for determining the presence of long-chain branches. For example, long-chain branching may be determined using ¹³C nuclear magnetic resonance (NMR) spectroscopy and to a limited extent; e.g., for ethylene homopolymers and for certain copolymers, and it can be quantified using the method of Randall (Journal of Macromolecular Science, Rev. Macromol. Chem. Phys., C29 (2&3), p. 285-297). Although conventional ¹³C NMR spectroscopy cannot determine the length of a long-chain branch in excess of about six carbon atoms, there are other known techniques useful for quantifying or determining the presence of long-chain branches in ethylene-based polymers, such as ethylene/1-octene interpolymers. For those ethylene-based polymers wherein the ¹³C resonances of the comonomer overlap completely with the ¹³C resonances of the long-chain branches, either the comonomer or the other monomers (such as ethylene) can be isotopically labeled so that the long-chain branches can be distinguished from the comonomer. For example, a copolymer of ethylene and 1-octene can be prepared using ¹³C-labeled ethylene. In this case, the resonances associated with macromer incorporation will be significantly enhanced in intensity and will show coupling to neighboring ¹³C carbons, whereas the octene resonances will be unenhanced.

Alternatively, the degree of long-chain branching in ethylene-based polymers may be quantified by determination of the branching index. The branching index g′ is defined by the following equation:

$${g}^{′} = \frac{{IV}_{Br}}{{IV}_{Lin}} {\vert}_{{M}_{w}}$$

where g′ is the branching index, IV_{Br} is the intrinsic viscosity of the branched ethylene-based polymer and IV_{Lin}, is the intrinsic viscosity of the corresponding linear ethylene-based polymer having the same weight average molecular weight and molecular weight distribution as the branched ethylene-based polymer, and in the case of copolymers and terpolymers, substantially the same relative molecular proportion or proportions of monomer units. For the purposes, the molecular weight and molecular weight distribution are considered “the same” if the respective values for the branched polymer and the corresponding linear polymer are within 10% of each other. Preferably, the molecular weights are the same and the MWD of the polymers are within 10% of each other. A method for determining intrinsic viscosity of polyethylene is described in Macromolecules, 2000, 33, 7489-7499. Intrinsic viscosity may be determined by dissolving the linear and branched polymers in an appropriate solvent, e.g., trichlorobenzene, typically measured at 135° C. Another method for measuring the intrinsic viscosity of a polymer is ASTM D-5225-98—Standard Test Method for Measuring Solution Viscosity of Polymers with a Differential Viscometer, which is incorporated by reference herein in its entirety. This method is the preferred method of measurement and relates to any branching value(s) described herein, including the examples and claims, unless otherwise specified.

The branching index, g′ is inversely proportional to the amount of branching. Thus, lower values for g′ indicate relatively higher amounts of branching. The amounts of short and long-chain branching each contribute to the branching index according to the formula: g′=g′_{LCB}×g′_{SCB}. Thus, the branching index due to long-chain branching may be calculated from the experimentally determined value for g′ as described by Scholte, et al., in J. App. Polymer Sci., 29, pp. 3763-3782 (1984), incorporated herein by reference.

Typically, the polyethylene polymers have a g′vis of 0.85 to 0.99, particularly, 0.87 to 0.97, 0.89 to 0.97, 0.91 to 0.97, 0.93 to 0.95, or 0.97 to 0.99.

The polyethylene polymers may be made by any suitable polymerization method including solution polymerization, slurry polymerization, and gas phase polymerization using supported or unsupported catalyst systems, such as a system incorporating a metallocene catalyst.

As used herein, the term “metallocene catalyst” is defined to comprise at least one transition metal compound containing one or more substituted or unsubstituted cyclopentadienyl moiety (Cp) (typically two Cp moieties) in combination with a Group 4, 5, or 6 transition metal, such as, zirconium, hafnium, and titanium.

Metallocene catalysts generally require activation with a suitable co-catalyst, or activator, in order to yield an “active metallocene catalyst”, i.e., an organometallic complex with a vacant coordination site that can coordinate, insert, and polymerize olefins. Active catalyst systems generally include not only the metallocene complex, but also an activator, such as an alumoxane or a derivative thereof (preferably methyl alumoxane), an ionizing activator, a Lewis acid, or a combination thereof. Alkylalumoxanes (typically methyl alumoxane and modified methylalumoxanes) are particularly suitable as catalyst activators. The catalyst system may be supported on a carrier, typically an inorganic oxide or chloride or a resinous material such as, for example, polyethylene or silica.

Zirconium transition metal metallocene-type catalyst systems are particularly suitable. Non-limiting examples of metallocene catalysts and catalyst systems useful in practicing the present invention include those described in, U.S. Pat. Nos. 5,466,649, 6,476,171, 6,225,426, and 7,951,873, and in the references cited therein, all of which are fully incorporated herein by reference. Particularly useful catalyst systems include supported dimethylsilyl bis(tetrahydroindenyl) zirconium dichloride.

Supported polymerization catalyst may be deposited on, bonded to, contacted with, or incorporated within, adsorbed or absorbed in, or on, a support or carrier. In another embodiment, the metallocene is introduced onto a support by slurrying a presupported activator in oil, a hydrocarbon such as pentane, solvent, or non-solvent, then adding the metallocene as a solid while stirring. The metallocene may be finely divided solids. Although the metallocene is typically of very low solubility in the diluting medium, it is found to distribute onto the support and be active for polymerization. Very low solubilizing media such as mineral oil (e.g., Kaydo™ or Drakol™) or pentane may be used. The diluent can be filtered off and the remaining solid shows polymerization capability much as would be expected if the catalyst had been prepared by traditional methods such as contacting the catalyst with methylalumoxane in toluene, contacting with the support, followed by removal of the solvent. If the diluent is volatile, such as pentane, it may be removed under vacuum or by nitrogen purge to afford an active catalyst. The mixing time may be greater than 4 hours, but shorter times are suitable.

Typically in a gas phase polymerization process, a continuous cycle is employed where in one part of the cycle of a reactor, a cycling gas stream, otherwise known as a recycle stream or fluidizing medium, is heated in the reactor by the heat of polymerization. This heat is removed in another part of the cycle by a cooling system external to the reactor. (See e.g., U.S. Pat. Nos. 4,543,399, 4,588,790, 5,028,670, 5,317,036, 5,352,749, 5,405,922, 5,436,304, 5,453,471, 5,462,999, 5,616,661, and 5,668,228, all of which are fully incorporated herein by reference.)

Generally, in a gas fluidized bed process for producing polymers, a gaseous stream containing one or more monomers is continuously cycled through a fluidized bed in the presence of a catalyst under reactive conditions. The gaseous stream is withdrawn from the fluidized bed and recycled back into the reactor. Simultaneously, polymer product is withdrawn from the reactor and fresh monomer is added to replace the polymerized monomer. The reactor pressure may vary from 100 psig (680 kPag)-500 psig (3448 kPag), or in the range of from 200 psig (1379 kPag)-400 psig (2759 kPag), or in the range of from 250 psig (1724 kPag)-350 psig (2414 kPag). The reactor may be operated at a temperature in the range of 60° C. to 120° C., 60° C. to 115° C., 70° C. to 110° C., 75° C. to 95° C., or 80° C. to 95° C. The productivity of the catalyst or catalyst system is influenced by the main monomer partial pressure. The mole percent of the main monomer, ethylene, may be from 25.0-90.0 mole percent, or 50.0-90.0 mole percent, or 70.0-85.0 mole percent, and the monomer partial pressure may be in the range of from 75 psia (517 kPa)-300 psia (2069 kPa), or 100-275 psia (689-1894 kPa), or 150-265 psia (1034-1826 kPa), or 200-250 psia (1378-1722 kPa).

To obtain the inventive polymers and films made therefrom, individual flow rates of ethylene, comonomer, and hydrogen should be controlled in accordance with the inventive Examples disclosed herein.

Other gas phase processes contemplated by the process of the invention include those described in U.S. Patent Nos. 5,627,242, 5,665,818, 5,677,375, and 6,255,426 and European published patent applications EP-A-0 794 200, EP-A-0 802 202, and EP-B-0 634 421, all of which are herein fully incorporated by reference.

Additionally, the use of a process continuity aid, while not required, may be desirable in any of the foregoing processes. Such continuity aids are well known to persons of skill in the art and include, for example, metal stearates.

### Additional Polymers

Additional polymers may be combined with the polyethylene polymer described above in a blend in a monolayer film or in one or more layers in a multilayer film. The additional polymers may include other polyolefin polymers such as ethylene-based and/or propylene-based polymers.

### First Additional Polyethylene Polymer

The first additional polyethylene polymer may be a metallocene-catalyze polyethylene polymer having about 99.0 to about 80.0 wt %, 99.0 to 85.0 wt %, 99.0 to 87.5 wt %, 99.0 to 90.0 wt %, 99.0 to 92.5 wt %, 99.0 to 95.0 wt %, or 99.0 to 97.0 wt %, of polymer units derived from ethylene and about 1.0 to about 20.0 wt %, 1.0 to 15.0 wt %, 1.0 to 12.5 wt %, 1.0 to 10.0 wt %, 1.0 to 7.5 wt %, 1.0 to 5.0 wt %, or 1.0 to 3.0 wt % of polymer units derived from one or more C₃ to C₂₀ α-olefin comonomers, preferably C₃ to C₁₀ α-olefins, and more preferably C₄ to C₈ α-olefins, such as hexene and octene. The α-olefin comonomer may be linear or branched, and two or more comonomers may be used, if desired. Examples of suitable comonomers include propylene, butene, 1-pentene; 1-pentene with one or more methyl, ethyl, or propyl substituents; 1-hexene; 1-hexene with one or more methyl, ethyl, or propyl substituents; 1-heptene; 1-heptene with one or more methyl, ethyl, or propyl substituents; 1-octene; 1-octene with one or more methyl, ethyl, or propyl substituents; 1-nonene; 1-nonene with one or more methyl, ethyl, or propyl substituents; ethyl, methyl, or dimethyl-substituted 1-decene; 1-dodecene; and styrene. Particularly suitable comonomers include 1-butene, 1-hexene, and 1-octene, 1-hexene being most preferred.

The first additional polyethylene polymer may have a melt index, I_{2.16,} according to ASTM D1238 (190° C./2.16 kg), of ≥about 0.10 g/10 min., e.g., ≥about 0.15 g/10 min., ≥about 0.18 g/10 min., ≥about 0.20 g/10 min., ≥about 0.22 g/10 min., ≥about 0.25 g/10 min., ≥about 0.28 g/10 min., or ≥about 0.30 g/10 min and, also, a melt index (I_{2.16}) ≤about 3.00 g/10 min., e.g., ≤about 2.00 g/10 min., ≤about 1.00 g/10 min., ≤about 0.70 g/10 min., ≤about 0.50 g/10 min., ≤about 0.40 g/10 min., or ≤about 0.30 g/10 min. Ranges expressly disclosed include, but are not limited to, ranges formed by combinations any of the above-enumerated values, e.g., about 0.10 to about 0.30, about 0.15 to about 0.25, about 0.18 to about 0.22 g/10 min., etc.

The first additional polyethylene polymer may have a melt index ratio (MIR) from 25 to 60, alternatively, from 30 to 55, alternatively, from 35 to 50, and alternatively, from 40 to 46. MIR is defined as I_{21.6}/I_{2.16} according to ASTM D1238 at 190° C.

The first additional polyethylene polymer may have a density about 0.918 g/cm³ ≥about 0.920 g/cm³, e.g., ≥about 0.922 g/cm³, ≥about 0.928 g/cm³, ≥about 0.930 g/cm³, ≥about 0.932 g/cm³. Additionally, the first polyethylene polymer may have a density ≤about 0.945 g/cm³, e.g., ≤about 0.940 g/cm³, ≤about 0.937 g/cm³, ≤about 0.935 g/cm³, ≤about 0.933 g/cm³, or ≤about 0.930 g/cm³. Ranges expressly disclosed include, but are not limited to, ranges formed by combinations any of the above-enumerated values, e.g., about 0.920 to about 0.945 g/cm³, 0.920 to 0.930 g/cm³, 0.925 to 0.935 g/cm³, 0.920 to 0.940 g/cm³, etc. Density is determined using chips cut from plaques compression molded in accordance with ASTM D-1928 Procedure C, aged in accordance with ASTM D-618 Procedure A, and measured as specified by ASTM D-1505.

Typically, the first additional polyethylene polymer may have a molecular weight distribution (MWD, defined as M_{w}/Mₙ) of about 2.5 to about 5.5, preferably 3.0 to 5.0 and about 3.0 to 4.5.

Suitable commercial polymers for the first additional polyethylene polymer are available from ExxonMobil Chemical Company as ENABLE™ metallocene polyethylene (mPE) resins.

### Second Additional Polyethylene Polymer

The shrink films may also comprise a second additional polyethylene polymer. The second additional polyethylene polymers are ethylene-based polymers comprising ≥50.0 wt % of polymer units derived from ethylene and ≤50.0 wt % preferably 1.0 wt % to 35.0 wt %, even more preferably 1 to 6 wt % of polymer units derived from a C₃ to C₂₀ alpha-olefin comonomer (for example, hexene or octene).

The second additional polyethylene polymer may have a density of ≥about 0.910 g/cm³, ≥about 0.915 g/cm³, ≥about 0.920 g/cm³, ≥about 0.925 g/cm³, ≥about 0.930 g/cm³, or ≥about 0.940 g/cm³. Alternatively, the second polyethylene polymer may have a density of ≤about 0.950 g/cm³, e.g., ≤about 0.940 g/cm³, ≤about 0.930 g/cm³, ≤about 0.925 g/cm³, ≤about 0.920 g/cm³, or ≤about 0.915 g/cm³. Ranges expressly disclosed include ranges formed by combinations any of the above-enumerated values, e.g., 0.910 to 0.950 g/cm³, 0.910 to 0.930 g/cm³, 0.910 to 0.925 g/cm³, etc. Density is determined using chips cut from plaques compression molded in accordance with ASTM D-1928 Procedure C, aged in accordance with ASTM D-618 Procedure A, and measured as specified by ASTM D-1505.

The second additional polyethylene polymer may have a melt index (I_{2.16}) according to ASTM D1238 (190° C./2.16 kg) of ≥about 0.5 g/10 min., e.g., ≥about 0.5 g/10 min., ≥about 0.7 g/10 min., ≥about 0.9 g/10 min., ≥about 1.1 g/10 min., ≥about 1.3 g/10 min., ≥about 1.5 g/10 min., or ≥about 1.8 g/10 min. Alternatively, the melt index (I_{2.16}) may be ≤about 8.0 g/10 min., ≤about 7.5 g/10 min., ≤about 5.0 g/10 min., ≤about 4.5 g/10 min., ≤about 3.5 g/10 min., ≤about 3.0 g/10 min., ≤about 2.0 g/10 min., e.g., ≤about 1.8 g/10 min., ≤about 1.5 g/10 min., ≤about 1.3 g/10 min., ≤about 1.1 g/10 min., ≤about 0.9 g/10 min., or ≤about 0.7 g/10 min., 0.5 to 2.0 g/10 min., particularly 0.75 to 1.5 g/10 min. Ranges expressly disclosed include ranges formed by combinations any of the above-enumerated values, e.g., about 0.5 to about 8.0 g/10 min., about 0.7 to about 1.8 g/10 min., about 0.9 to about 1.5 g/10 min., about 0.9 to 1.3, about 0.9 to 1.1 g/10 min., about 1.0 g/10 min., etc.

In particular embodiments, the second additional polyethylene polymer may have a density of 0.910 to 0.920 g/cm³, a melt index (I_{2.16}) of 0.5 to 8.0 g/10 min., and a CDBI of 60.0% to 80.0%, preferably between 65% and 80%.

The second polyethylene polymers are generally considered linear. Suitable second additional polyethylene polymers are available from ExxonMobil Chemical Company under the trade name Exceed™ metallocene (mPE) resins. The MIR for Exceed materials will typically be from about 15 to about 20.

### Third Additional Polyethylene Polymer

The shrink film may also comprise a third additional polyethylene polymer. Suitable third additional polyethylene polymers may be a copolymer of ethylene, and one or more polar comonomers or C₃ to C₁₀ α-olefins. Typically, the third additional polyethylene polymer includes 99.0 wt % to about 80.0 wt %, 99.0 wt % to 85.0 wt %, 99.0 wt % to 87.5 wt %, 95.0 wt % to 90.0 wt %, of polymer units derived from ethylene and about 1.0 to about 20.0 wt %, 1.0 wt % to 15.0 wt %, 1.0 wt % to 12.5 wt %, or 5.0 wt % to 10.0 wt % of polymer units derived from one or more polar comonomers, based upon the total weight of the polymer. Suitable polar comonomers include, but are not limited to: vinyl ethers such as vinyl methyl ether, vinyl n-butyl ether, vinyl phenyl ether, vinyl beta-hydroxy-ethyl ether, and vinyl dimethylamino-ethyl ether; olefins such as propylene, butene-1, cis-butene-2, trans-butene-2, isobutylene, 3,3,-dimethylbutene-1, 4-methylpentene-1, octene-1, and styrene; vinyl type esters such as vinyl acetate, vinyl butyrate, vinyl pivalate, and vinylene carbonate; haloolefins such as vinyl fluoride, vinylidene fluoride, tetrafluoroethylene, vinyl chloride, vinylidene chloride, tetrachloroethylene, and chlorotrifluoroethylene; acrylic-type esters such as methyl acrylate, ethyl acrylate, n-butyl acrylate, t-butyl acrylate, 2-ethylhexyl acrylate, alpha-cyanoisopropyl acrylate, beta-cyanoethyl acrylate, o-(3-phenylpropan-1,3,-dionyl)phenyl acrylate, methyl methacrylate, n-butyl methacrylate, t-butyl methacrylate, cyclohexyl methacrylate, 2-ethylhexyl methacrylate, methyl methacrylate, glycidyl methacrylate, beta-hydroxethyl methacrylate, beta-hydroxpropyl methacrylate, 3-hydroxy-4-carbo-methoxy-phenyl methacrylate, N,N-dimethylaminoethyl methacrylate, t-butylaminoethyl methacrylate, 2-(1-aziridinyl)ethyl methacrylate, diethyl fumarate, diethyl maleate, and methyl crotonate; other acrylic-type derivatives such as acrylic acid, methacrylic acid, crotonic acid, maleic acid, methyl hydroxy maleate, itaconic acid, acrylonitrile, fumaronitrile, N,N-dimethylacrylamide, N-isopropylacrylamide, N-t-butylacrylamide, N-phenylacrylamide, diacetone acrylamide, methacrylamide, N-phenylmethacrylamide, N-ethylmaleimide, and maleic anhydride; and other compounds such as allyl alcohol, vinyltrimethylsilane, vinyltriethoxysilane, N-vinylcarbazole, N-vinyl-N-methylacetamide, vinyldibutylphosphine oxide, vinyldiphenylphosphine oxide, bis-(2-chloroethyl) vinylphosphonate, and vinyl methyl sulfide.

In some embodiments, the third additional polyethylene polymer is an ethylene/vinyl acetate copolymer having about 2.0 wt % to about 15.0 wt %, typically about 5.0 wt % to about 10.0 wt %, polymer units derived from vinyl acetate, based on the amounts of polymer units derived from ethylene and vinyl acetate (EVA). In certain embodiments, the EVA resin can further include polymer units derived from one or more comonomer units selected from propylene, butene, 1-hexene, 1-octene, and/or one or more dienes.

Suitable dienes include, for example, 1,4-hexadiene, 1,6-octadiene, 5-methyl-1,4-hexadiene, 3,7-dimethyl-1,6-octadiene, dicyclopentadiene (DCPD), ethylidene norbornene (ENB), norbornadiene, 5-vinyl-2-norbornene (VNB), and combinations thereof.

The third additional polyethylene polymers are available from ExxonMobil Chemical Company as ExxonMobil™ Low Density Polyethylene (LDPE) or Nexxstar™ resins.

A fourth additional polyethylene polymer may also be present as High Density Polyethylene (HDPE). The HDPE may be unimodal or bimodal/multimodal and have a narrow molecular weight distribution (MWD) or broad MWD.

### Propylene-Based Polymer

The shrink film may also comprise a propylene-based polymer or elastomer (“PBE”), which comprises propylene and from about 5 wt % to about 25 wt % of one or more comonomers selected from ethylene and/or C₄-C₁₂ α-olefins. In one or more embodiments, the α-olefin comonomer units may be derived from ethylene, butene, pentene, hexene, 4-methyl-1-pentene, octene, or decene. The embodiments described below are discussed with reference to ethylene as the α-olefin comonomer, but the embodiments are equally applicable to other copolymers with other α-olefin comonomers. In this regard, the copolymers may simply be referred to as propylene-based polymers with reference to ethylene as the α-olefin.

In one or more embodiments, the PBE may include at least about 2 wt %, at least about 3 wt %, at least about 4 wt %, at least about 5 wt %, at least about 6 wt %, at least about 7 wt %, or at least about 8 wt %, or at least about 9 wt %, or at least about 10 wt %, or at least about 12 wt % ethylene-derived units. In those or other embodiments, the PBE may include up to about 30 wt %, or up to about 25 wt %, or up to about 22 wt %, or up to about 20 wt %, or up to about 19 wt %, or up to about 18 wt %, or up to about 17 wt % ethylene-derived units, where the percentage by weight is based upon the total weight of the propylene-derived and α-olefin derived units. Stated another way, the PBE may include at least about 70 wt %, or at least about 75 wt %, or at least about 80 wt %, or at least about 81 wt % propylene-derived units, or at least about 82 wt % propylene-derived units, or at least about 83 wt % propylene-derived units; and in these or other embodiments, the PBE may include up to about 95 wt %, or up to about 94 wt %, or up to about 93 wt %, or up to about 92 wt %, or up to about 90 wt %, or up to about 88 wt % propylene-derived units, where the percentage by weight is based upon the total weight of the propylene-derived and α-olefin derived units. In certain embodiments, the PBE may comprise from about 5 wt % to about 25 wt % ethylene-derived units, or from about 9 wt % to about 18 wt % ethylene-derived units.

The PBEs of one or more embodiments are characterized by a melting point (Tm), which can be determined by differential scanning calorimetry (DSC). For purposes herein, the maximum of the highest temperature peak is considered to be the melting point of the polymer. A “peak” in this context is defined as a change in the general slope of the DSC curve (heat flow versus temperature) from positive to negative, forming a maximum without a shift in the baseline where the DSC curve is plotted so that an endothermic reaction would be shown with a positive peak.

In one or more embodiments, the Tm of the PBE (as determined by DSC) is less than about 115° C., or less than about 110° C., or less than about 100° C., or less than about 95° C., or less than about 90° C.

In one or more embodiments, the PBE may be characterized by its heat of fusion (Hf), as determined by DSC. In one or more embodiments, the PBE may have an Hf that is at least about 0.5 J/g, or at least about 1.0 J/g, or at least about 1.5 J/g, or at least about 3.0 J/g, or at least about 4.0 J/g, or at least about 5.0 J/g, or at least about 6.0 J/g, or at least about 7.0 J/g. In these or other embodiments, the PBE may be characterized by an Hf of less than about 75 J/g, or less than about 70 J/g, or less than about 60 J/g, or less than about 50 J/g, or less than about 45 J/g, or less than about 40 J/g, or less than about 35 J/g, or less than about 30 J/g.

As used within this specification, DSC procedures for determining Tm and Hf include the following. The polymer is pressed at a temperature of from about 200° C. to about 230° C. in a heated press, and the resulting polymer sheet is hung, at about 23° C., in the air to cool. About 6 to 10 mg of the polymer sheet is removed with a punch die. This 6 to 10 mg sample is annealed at about 23° C. for about 80 to 100 hours. At the end of this period, the sample is placed in a DSC (Perkin Elmer Pyris One Thermal Analysis System) and cooled at a rate of about 10° C./min to about −50° C. to about −70° C. The sample is heated at a rate of about 10° C./min to attain a final temperature of about 200° C. The sample is kept at 200° C. for 5 minutes and a second cool-heat cycle is performed. Events from both cycles are recorded. The thermal output is recorded as the area under the melting peak of the sample, which typically occurs between about 0° C. and about 200° C. It is measured in Joules and is a measure of the Hf of the polymer.

The PBE can have a triad tacticity of three propylene units, as measured by 13C NMR, of 75% or greater, 80% or greater, 85% or greater, 90% or greater, 92% or greater, 95% or greater, or 97% or greater. In one or more embodiments, the triad tacticity may range from about 75 to about 99%, or from about 80 to about 99%, or from about 85 to about 99%, or from about 90 to about 99%, or from about 90 to about 97%, or from about 80 to about 97%. Triad tacticity is determined by the methods described in U.S. Pat. No. 7,232,871.

The PBE may have a tacticity index ranging from a lower limit of 4 or 6 to an upper limit of 8 or 10 or 12. The tacticity index, expressed herein as “m/r”, is determined by ¹³C nuclear magnetic resonance (“NMR”). The tacticity index, m/r, is calculated as defined by H. N. Cheng in 17 MACROMOLECULES 1950 (1984). The designation “m” or “r” describes the stereochemistry of pairs of contiguous propylene groups, “m” referring to meso and “r” to racemic. An m/r ratio of 1.0 generally describes a syndiotactic polymer, and an m/r ratio of 2.0 an atactic material. An isotactic material theoretically may have a ratio approaching infinity, and many by-product atactic polymers have sufficient isotactic content to result in ratios of greater than 50.

In one or more embodiments, the PBE may have a % crystallinity of from about 0.5% to about 40%, or from about 1% to about 30%, or from about 5% to about 25%, determined according to DSC procedures. Crystallinity may be determined by dividing the Hf of a sample by the Hf of a 100% crystalline polymer, which is assumed to be 189 joules/gram for isotactic polypropylene or 350 joules/gram for polyethylene.

In one or more embodiments, the PBE may have a density of from about 0.85 g/cm³ to about 0.92 g/cm³, or from about 0.86 g/cm³ to about 0.90 g/cm³, or from about 0.86 g/cm³ to about 0.89 g/cm³ at room temperature, as measured per the ASTM D-792.

In one or more embodiments, the PBE can have a melt index (MI) (ASTM D-1238, 2.16 kg @ 190° C.), of less than or equal to about 100 g/10 min., or less than or equal to about 50 g/10 min., or less than or equal to about 25 g/10 min., or less than or equal to about 10 g/10 min., or less than or equal to about 9.0 g/10 min., or less than or equal to about 8.0 g/10 min., or less than or equal to about 7.0 g/10 min.

In one or more embodiments, the PBE may have a melt flow rate (MFR), as measured according to ASTM D-1238 (2.16 kg weight @ 230° C.), greater than about 1 g/10 min., or greater than about 2 g/10 min., or greater than about 5 g/10 min., or greater than about 8 g/10 min., or greater than about 10 g/10 min. In the same or other embodiments, the PBE may have an MFR less than about 500 g/10 min., or less than about 400 g/10 min., or less than about 300 g/10 min., or less than about 200 g/10 min., or less than about 100 g/10 min., or less than about 75 g/10 min., or less than about 50 g/10 min. In certain embodiments, the PBE may have an MFR from about 1 to about 100 g/10 min., or from about 2 to about 75 g/10 min., or from about 5 to about 50 g/10 min.

Suitable commercially available propylene-based polymers include Vistamaxx™ Performance Polymers from ExxonMobil Chemical Company and Versify™ Polymers from The Dow Chemical Company.

### Polymer Blends

The shrink films may include monolayer films made from blends of the polymers described above or, if multilayer film, one or more layers may comprise a blend of the polymers described above, optionally, blended with other polymers known in the art to produce the shrink films.

For example, in a class of embodiments of the invention, the shrink film may comprise from 50 wt % to 100 wt % of the polyethylene polymer described above, based upon the total weight of the film, and if the shrink film comprises one or more layers, at least one layer may comprise from 50 wt % to 100 wt % of the polyethylene polymer, based upon the total weight of the at least one layer. Alternative embodiments include from 50 wt % to 90 wt %, from 60 wt % to 80 wt %, or from 60 wt % to 70 wt %, of the polyethylene polymer.

If an additional polyethylene polymer is present as described above, for example LDPE, the shrink film may comprise from 10 wt % to 50 wt % of the additional polyethylene polymer described above, based upon the total weight of the film, and if the shrink film comprises one or more layers, at least one layer may comprise from 10 wt % to 50 wt % of the additional polyethylene polymer, based upon the total weight of the at least one layer. Alternative embodiments include from 10 wt % to 40 wt %, from 20 wt % to 40 wt %, or from 25 wt % to 35 wt %, of the polyethylene polymer.

If a propylene-based polymer is present as described above, for example Vistamaxx™ Performance Polymer, the shrink film may comprise from 1 wt % to 30 wt % of the propylene-based polymer, based upon the total weight of the film, and if the shrink film comprises one or more layers, at least one layer may comprise from 1 wt % to 30 wt % of the propylene-based polymer, based upon the total weight of the at least one layer. Alternative embodiments include from 1 wt % to 25 wt %, from 1 wt % to 20 wt %, or from 10 wt % to 20 wt %, of the propylene-based polymer.

### Shrink Films

The above-described polymers and combinations thereof are particularly suitable for shrink film applications. As used herein, the term “shrink film” or “heat-shrinkable film” refers to a film capable of being shrunk by application of heat, typically, hot air.

The shrink films may be cast or blown films having a single layer (monolayer) or multiple layers (multilayer films). Shrink films, also referred to as heat-shrinkable films, are widely used in both industrial and retail bundling and packaging applications. Such films are capable of shrinking upon application of heat to release stress imparted to the film during or subsequent to extrusion. The shrinkage can occur in one direction, for example, machine direction (MD), or in both MD direction and transverse direction (TD). Conventional shrink films are described, for example, in WO 2004/022646.

Industrial shrink films are commonly used for bundling articles on pallets. Typical industrial shrink films are formed in a single bubble blown extrusion process and provide shrinkage in two directions, typically at a machine direction to transverse direction.

Retail films are commonly used for packaging and/or bundling articles for consumer use, such as, for example, in supermarket goods, consumer products, toys, etc.

One use for shrink films made from the polymers and/or blends described herein is in “shrink-on-shrink” applications. “Shrink-on-shrink,” as used herein, refers to the process of applying an outer shrink wrap layer around one or more items that have already been individually shrink wrapped (herein, the “inner layer” of wrapping). In these processes, it is desired that the films used for wrapping the individual items have a higher melting (or shrinking) point than the film used for the outside layer. When such a configuration is used, it is possible to achieve the desired level of shrinking in the outer layer, while preventing the inner layer from melting, further shrinking, or otherwise distorting during shrinking of the outer layer.

With reference to multilayer film structures of the invention comprising the same or different layers, the following notation may be used for illustration. Each layer of a film is denoted “A” or “B”. Where a film includes more than one A layer or more than one B layer, one or more prime symbols (′, ″, ′″, etc.) are appended to the A or B symbol to indicate layers of the same type that can be the same or can differ in one or more properties, such as chemical composition, density, melt index, thickness, etc. Finally, the symbols for adjacent layers are separated by a slash (/). Using this notation, a three-layer film having an inner layer of the polyethylene resin or blend of the invention between two outer, film layers would be denoted A/B/A′. Similarly, a five-layer film of alternating layers would be denoted A/B/A′/B′/A″. Unless otherwise indicated, the left-to-right or right-to-left order of layers does not matter, nor does the order of prime symbols; e.g., an A/B film is equivalent to a B/A film, and an A/A′/B/A″ film is equivalent to an A/B/A′/A″ film.

In another class of embodiments, and using the nomenclature described above, the present invention provides multilayer films with any of the following exemplary structures: (a) two-layer films, such as A/B and B/B′; (b) three-layer films, such as A/B/A′, A/A′/B, B/A/B′ and B/B′/B″; (c) four-layer films, such as A/A′/A″/B, A/A′/B/A″, A/A′/B/B′, A/B/A′/B′, A/B/B′/A′, B/A/A′/B′, A/B/B′/B″, B/A/B′/B″ and B/B′/B″/B′″; (d) five-layer films, such as A/A′/A″/A′″/B, A/A′A″/B/A′″, A/A′/B/A″/A′″, A/A′/A″/B/B′, A/A′/B/A″/B′, A/A′/B/B′/A″, A/B/A′/B′/A″, A/B/A′/A″/B, B/A/A′/A″/B′, A/A′/B/B′/B″, A/B/A′/B′/B″, A/B/B′/B″/A′, B/A/A′/B′/B″, B/A/B′/A′/B″, B/A/B′/B″/A′, A/B/B′B″/B′″, B/A/B′/B″/B′″, B/B′/A/B″/B′′, and B/B′/B″B′″/B″″; and similar structures for films having six, seven, eight, nine, ten, eleven, twelve, thirteen, fourteen, fifteen, sixteen, seventeen, eighteen, nineteen, twenty, or more layers. It should be appreciated that films having still more layers, for example, films that comprise nanolayers, may be formed using the polymers and blends of the invention, and such films are within the scope of the invention.

The films may further be embossed, or produced or processed according to other known film processes.

The films may be tailored to specific applications by adjusting the thickness, materials and order of the various layers, as well as the additives in each layer.

The films may be formed by any number of well-known extrusion or coextrusion techniques. Any of the blown or cast film techniques commonly used are suitable. For example, a resin composition may be extruded in a molten state through a flat die and then cooled to form a film, in a cast film process.

Alternatively, the composition may be extruded in a molten state through an annular die and then blown and cooled to form a tubular, blown film, which can then be axially slit and unfolded to form a flat film. Films of the invention may be unoriented, uniaxially oriented, or biaxially oriented.

As an illustration, blown films may be prepared as follows. The resin composition is introduced into the feed hopper of an extruder, and the film is extruded through the extruder die into a film and cooled by blowing air onto the surface of the film. The film is drawn from the die typically forming a cylindrical film that is cooled, collapsed and optionally subjected to a desired auxiliary process, such as slitting, treating, sealing or printing. The finished film may be wound into rolls for later processing. An exemplary blown film process and apparatus suitable for forming films according to some embodiments of the invention is described in U. S. Pat. No. 5,569,693.

Multiple layer films may be formed by methods well known in the art. The materials forming each layer may be coextruded through a coextrusion feedblock and die assembly to yield a film with two or more layers adhered together but differing in composition. Coextrusion may be adapted to cast film or blown film processes. Multiple layer films may also be formed by combining two or more single layer films prepared as described above.

In a class of embodiments, the invention also provides for a process to produce a shrink film comprising: a) obtaining a polyethylene polymer comprising at least 65 wt % ethylene derived units, based upon the total weight of the polymer, having: i. a melt index (MI) from about 0.1 g/10 min to about 2.0 g/10 min; ii. a density from about 0.905 g/cm³ to about 0.920 g/cm³; iii. a melt index ratio (MIR) from about 25 to about 80; and iv. a molecular weight (M_{w}) of about 85,000 or greater; b) extruding the polyethylene polymer to produce a molten material; and c) blowing the molten material to produce a bubble to produce the shrink film having a total shrink of from 100% to 200%. In several embodiments, the process is a single bubble extrusion process. The extruding temperature may range from 140° C. to 240° C., alternatively, from 190° C. to 240° C., and alternatively, from 200° C. to 240° C.

The total thickness of monolayer of multilayer films may vary based upon the application desired. A total film thickness of from about 0.1 to about 5.0 mil is suitable for most shrink film applications. Alternative embodiments of the invention include from about 0.5 to about 3.0 mil, from about 0.5 to about 2.0 mil, from about 0.6 to about 1.5 mil, or from about 0.8 to about 1.0 mil. Those skilled in the art will appreciate that the thickness of individual layers for multilayer films may be adjusted based on desired end use performance, resin or copolymer employed, equipment capability and other factors.

In any of the embodiments of the invention, the shrink films may have a total shrink of from 100% to 200% as measured according to free shrink test described in Test Method Section. Alternative embodiments includes a total shrink in the range of from 100% to 130%, alternatively, from 100% to 125%, and alternatively, from 105% to 125%.

In any of the embodiments of the invention, the shrink films may have a contracting force of 1.5 N or less as measured according to shrink and contracting force test described in Test Method Section. Alternative embodiments includes a contracting force of 1.0 N or less, alternatively, 0.75 N or less, and alternatively, 0.5 N or less.

In a class of embodiments, the shrink films have good optical properties. For example, the haze of the films may be 25% or lower, 20% or lower, 15% or lower, 10% or lower, as measured by ASTM D 1003.

### Test Methods

The properties cited below were determined in accordance with the following test procedures. Where any of these properties is referenced in the appended claims, it is to be measured in accordance with the specified test procedure.

Where applicable, the properties and descriptions below are intended to encompass measurements in both the machine and transverse directions. Such measurements are reported separately, with the designation “MD” indicating a measurement in the machine direction, and “TD” indicating a measurement in the transverse direction.

Film thickness, reported in microns, was measured using a Measuretech Series 200 instrument. The instrument measures film thickness using a capacitance gauge. For each film sample, ten film thickness datapoints were measured per inch of film as the film was passed through the gauge in a transverse direction. From these measurements, an average gauge measurement was determined and reported.

Elmendorf Tear, reported in grams (g), was measured as specified by ASTM D-1922.

1% Secant Modulus (M), reported in megapascal (MPa), was measured as specified by ASTM D-882.

Dart F_{50,} or Dart Drop Impact or Dart Drop Impact Strength (DIS), reported in grams (g), was measured as specified by ASTM D-1709, method A, unless otherwise specified.

Haze, reported in percentage (%), was measured as specified by ASTM D-1003.

“Free shrink”, reported in percentage (%), is measured in both machine (MD) and transverse (TD) directions in the following way. Round specimens of 50 mm diameter are cut out from film samples and marked with machine or transverse direction. Shrink is measured by reheating the film sample on a horizontal plane at 130° C. and 150° C. Silicon oil is applied between the film sample and the heated surface to prevent the samples from sticking to the heating plate and allowing a free shrinkage movement until no further shrinkage is observed. MD and TD shrinkage are then calculated. Total shrink is defined as the sum of MD and TD shrink.

“Shrink Force and Contracting Force”, reported in Newton (N), are measured using Retramat equipment based on ISO 14616. The method consists in exposing 2 film samples to a given temperature, during a given time, and to cool them down at room temperature, simulating what happens inside a shrinkage installation. Retramat equipment is equipped with a heated oven. During the test, one of the samples is connected to a force transducer, while the other is connected to a displacement transducer. A thermocouple provides for following up the temperature at a few millimeters from the middle of the sample. The 3 parameters (force-displacement-temperature) are continuously displayed on the Retramat and recorded on a lab PC. Shrink force is defined as force developed by the film when it reaches the temperature corresponding to that at which the stress was induced at the time of manufacture. Contracting force is defined as force developed by the film during its cooling process. The conditions for the test are: oven heated at 160° C., oven around the sample for 30 sec.

### EXAMPLES

It is to be understood that while the invention has been described in conjunction with the specific embodiments thereof, the foregoing description is intended to illustrate and not limit the scope of the invention. Other aspects, advantages and modifications will be apparent to those skilled in the art to which the invention pertains.

Therefore, the following examples are put forth so as to provide those skilled in the art with a complete disclosure and description and are not intended to limit the scope of that which the inventors regard as their invention.

PE1 was made according to inventive polymers disclosed in Ser. No. 62/219,846, filed Sep. 17, 2015, using a solid zirconocene catalyst disclosed in U.S. Pat. No. 6,476,171, Col. 7, line 10, bridging Col. 8, line 26, under polymerization conditions to produce an ethylene-hexene copolymer having density of 0.916 g/cm³, a melt index (I_{2.16}) of 0.2 g/10 min., and a melt index ratio (I_{21.6}/I_{2.16}) of 50. PE1 had a hexene content of 2.8 mole%, a Mn of 51,730 g/mole, a Mw of 130,893 g/mole and a Mz of 246,400 g/mole. The branching index of PE1, g′, is 0.954.

PE2 was made according to PE1 as described above except that the polymerization conditions to produce an ethylene-hexene copolymer varied. The melt index is different between PE1 and PE2 and this difference was obtained by varying the hydrogen during the polymerization process as recognized in the art. The ethylene-hexene copolymer (PE2) had a density of 0.916 g/cm³, a melt index (I_{2.16}) of 0.5 g/10 min., and a melt index ratio (I_{21.6}/I_{2.16}) of 37. PE2 had a hexene content of 2.8 mole%, a Mn of 28,984 g/mole, a Mw of 112,688 g/mole, and a Mz of 227,071 g/mole. The branching index of PE2, g′, is 0.950.

In Examples 1 and 2, two mono-layer shrink films were prepared using a blend of 70 wt % of PE1 and 30 wt % of a LDPE having a density of 0.922 g/cm³ and a melt index of 0.33 g/10 min available from ExxonMobil Chemical Company as LD165BW1. The blown film extrusion line was equipped with a die of 160 mm and die gap of 0.76 mm Film was fabricated under the conditions that are recorded in Table 1. Film 1 has film thickness of 21 micron. Film 2 has film thickness of 40 micron. Mechanical properties and shrink results are also included in Table 1.

TABLE 1

| | Film 1 | Film 2 |
|---|---|---|
| Film Thickness (micron) | 21 | 40 |
| Extrusion temperature (° C.) | 228 | 228 |
| Blow Up Ratio (BUR) | 4.3 | 4.3 |
| Total Extrusion Rate (kg/hr) | 90 | 90 |
| Frost Line Height (mm) | 1041 | 991 |
| 1% Secant Modulus, TD (MPa) | 220 | 195 |
| 1% Secant Modulus, MD (MPa) | 239 | 195 |
| MD Tear (g) | 65 | 208 |
| TD Tear (g) | 487 | 749 |
| Dart Drop Impact (g) | 191 | 458 |
| Haze (%) | 12.0 | 12.4 |
| Free Shrink at 130° C., MD (%) | 76 | 64 |
| Free Shrink at 130° C., TD (%) | 48 | 44 |
| Free Shrink at 130° C., Total (%) | 124 | 108 |
| Free Shrink at 150° C., MD (%) | 79 | 69 |
| Free Shrink at 150° C., TD (%) | 55 | 50 |
| Free Shrink at 150° C., Total (%) | 134 | 119 |
| Shrinking force at 160° C., MD (N) | 0.06 | 0.07 |
| Contracting Force at 160° C., MD (N) | 0.47 | 1.06 |
| Shrinking force at 160° C., TD (N) | 0.03 | 0.02 |
| Contracting Force at 160° C., TD (N) | 0.36 | 0.88 |

Examples 3 and 4, two mono-layer shrink films were prepared using a blend of 70 wt % of PE2 and 30 wt % of a LDPE having a density of 0.922 g/cm³ and a melt index of 0.33 g/10 min available from ExxonMobil Chemical Company as LD165BW1. The blown film extrusion line was equipped with a die of diameter 160 mm and die gap of 0.76 mm Film was fabricated under the conditions that are recorded in Table 2. Film 3 has film thickness of 21 micron. Film 4 has film thickness of 40 micron. Mechanical properties and shrink results are also included in Table 2.

TABLE 2

| | Film 3 | Film 4 |
|---|---|---|
| Film Thickness (micron) | 21 | 40 |
| Extrusion temperature (° C.) | 220 | 219 |
| Blow Up Ratio (BUR) | 4.3 | 4.3 |
| Total Extrusion Rate (kg/hr) | 90 | 90 |
| Frost Line Height (mm) | 991 | 991 |
| 1% Secant Modulus, TD (MPa) | 194 | 189 |
| 1% Secant Modulus, MD (MPa) | 216 | 192 |
| MD Tear (g) | 82 | 266 |
| TD Tear (g) | 493 | 530 |
| Dart Drop Impact (g) | 170 | 410 |
| Haze (%) | 10.1 | 10.7 |
| Free Shrink at 130° C., MD (%) | 72 | 65 |
| Free Shrink at 130° C., TD (%) | 44 | 44 |
| Free Shrink at 130° C., Total (%) | 116 | 109 |
| Free Shrink at 150° C., MD (%) | 77 | 70 |
| Free Shrink at 150° C., TD (%) | 51 | 49 |
| Free Shrink at 150° C., Total (%) | 128 | 119 |
| Shrinking force at 160° C., MD (N) | 0.05 | 0.04 |
| Contracting Force at 160° C., MD (N) | 0.44 | 0.95 |
| Shrinking force at 160° C., TD (N) | 0.01 | 0.02 |
| Contracting Force at 160° C., TD (N) | 0.37 | 0.83 |

Examples 5 to 6, two mono-layer shrink films of 40 micron were prepared by blow film extrusion. Film 5 uses a blend of 60 wt % of PE1, 30 wt % of a LDPE having a density of 0.922 g/cm3 and a melt index of 0.33 g/10 min available from ExxonMobil Chemical Company as LD165BW1, and 10% of a propylene based elastomer having a density of 0.889g/cm³, a melt mass flow rate of 8 g/10 min., and ethylene content of 4 wt % available from ExxonMobil Chemical Company as Vistamaxx™ Performance Polymer 3588FL. Film 6 uses a blend of 50 wt % of PE1, 30 wt % of a LDPE having a density of 0.922 g/cm³ and a melt index of 0.33 g/10 min available from ExxonMobil Chemical Company as LD165BW1, and 20% of a propylene based elastomer having a density of 0.889g/cm³, a melt mass flow rate of 8 g/10 min., and ethylene content of 4 wt % available from ExxonMobil Chemical Company as Vistamaxx™ Performance Polymer 3588FL. The blown film extrusion line was equipped with a die of diameter 160 mm and die gap of 0.76 mm Film was fabricated under the conditions that are recorded in Table 3. Mechanical properties and shrink results are also included in Table 3. Shrink tension can be reduced by the addition of the elastomer.

TABLE 3

| | Film 6 | Film 7 |
|---|---|---|
| Film Thickness (micron) | 40 | 40 |
| Extrusion temperature (° C.) | 227 | 220 |
| Blow Up Ratio (BUR) | 4.2 | 4.2 |
| Total Extrusion Rate (kg/hr) | 90 | 90 |
| Frost Line Height (mm) | 965 | 991 |
| 1% Secant Modulus, TD (MPa) | 202 | 212 |
| 1% Secant Modulus, MD (MPa) | 212 | 240 |
| MD Tear (g) | 231 | 224 |
| TD Tear (g) | 964 | 1,040 |
| Dart Drop Impact (g) | 311 | 230 |
| Haze (%) | 13.0 | 23.7 |
| Free Shrink at 130° C., MD (%) | 66 | 69 |
| Free Shrink at 130° C., TD (%) | 46 | 48 |
| Free Shrink at 130° C., Total (%) | 112 | 117 |
| Free Shrink at 150° C., MD (%) | 71 | 74 |
| Free Shrink at 150° C., TD (%) | 51 | 51 |
| Free Shrink at 150° C., Total (%) | 122 | 125 |
| Shrinking force at 160° C., MD (N) | 0.07 | 0.08 |
| Contracting Force at 160° C., MD (N) | 0.96 | 0.76 |
| Shrinking force at 160° C., TD (N) | 0.03 | 0.02 |
| Contracting Force at 160° C., TD (N) | 0.68 | 0.55 |

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the invention, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All priority documents are herein fully incorporated by reference for all jurisdictions in which such incorporation is permitted and to the extent such disclosure is consistent with the description of the present invention. Further, all documents and references cited herein, including testing procedures, publications, patents, journal articles, etc. are herein fully incorporated by reference for all jurisdictions in which such incorporation is permitted and to the extent such disclosure is consistent with the description of the present invention.

While the invention has been described with respect to a number of embodiments and examples, those skilled in the art, having benefit of this disclosure, will appreciate that other embodiments can be devised which do not depart from the scope and spirit of the invention as disclosed herein.

1. A shrink film comprising:
a polyethylene polymer comprising at least 65 wt % ethylene derived units, based upon the total weight of the polymer, having:
a. a melt index (MI) from about 0.1 g/10 min to about 2.0 g/10 min;
b. a density from about 0.905 g/cm³ to about 0.920 g/cm³; and
c. a melt index ratio (MIR) from about 25 to about 80;
wherein the shrink film has a total shrink of from 100% to 200%, and a contracting force of 1.5 N or less.

2. The shrink film of claim 1, wherein the shrink film has a total shrink of from 100% to 130% measured between 120° C. and 160° C.

3. The shrink film of claim 1, wherein the shrink film has a total shrink of from 105% to 125% measured between 130° C. and 150° C.

4. The shrink film of claim 1, wherein the shrink film has a contracting force of 1.0 N or less.

5. The shrink film of claim 1, wherein the shrink film has an average secant modulus of from 150 to 275 MPa.

6. The shrink film of claim 1, wherein the shrink film has an average secant modulus of from 150 to 240 MPa.

7. The shrink film of claim 1, wherein the shrink film has a film thickness of from 10 micron to 50 micron.

8. The shrink film of claim 1, wherein the shrink film comprises a blend of the polyethylene polymer.

9. The shrink film of claim 1, wherein the shrink film comprises one or more layers and the one or more layers comprise a composition made from the polyethylene polymer.

10. The shrink film of claim 1, wherein the shrink film is a cast film or a coextruded blown film, optionally, oriented in the machine direction and/or transverse direction.

11. The shrink film of claim 1, wherein the shrink film comprises from 50 wt % to 90 wt % of the polyethylene polymer, based upon the total weight of the film, and if the shrink film comprises one or more layers, at least one layer comprises from 50 wt % to 90 wt % of the polyethylene polymer, based upon the total weight of the at least one layer.

12. The shrink film of claim 1, wherein the shrink film further comprises a low density polyethylene polymer (LDPE).

13. The shrink film of claim 12, wherein the shrink film comprises from 10 wt % to 50 wt % of the LDPE, based upon the total weight of the film, and if the shrink film comprises one or more layers, at least one layer comprises from 10 wt % to 50 wt % of the LDPE, based upon the total weight of the at least one layer.

14. The shrink film of claim 1, wherein the shrink film further comprises a propylene-based polymer.

15. The shrink film of claim 14, wherein the shrink film comprises from 1 wt % to 20 wt % of the propylene-based polymer, based upon the total weight of the film, and if the shrink film comprises one or more layers, at least one layer comprises from 1 wt % to 20 wt % of the propylene based polymer, based upon the total weight of the at least one layer.

16. The shrink film of claim 1, wherein the polyethylene polymer has a density from about 0.910 g/cm³ to about 0.915 g/cm³ and/or a melt index (MI) from about 0.2 g/10 min to about 1.0 g/10 min.

17. The shrink film of claim 1, wherein the polyethylene polymer has a melt index ratio (MIR) from about 30 to about 80.

18. The shrink film of claim 1, wherein the polyethylene polymer exhibits long chain branching and/or a g′ branching index from about 0.93 to about 0.99.

19. The shrink film of claim 1, wherein the polyethylene polymer has a melt strength of about 1 cN to about 25 cN.

20. The shrink film of claim 1, wherein the polyethylene polymer has a T₇₅-T₂₅ value from 5.0 to 10, where T₂₅ is the temperature in degrees Celsius at which 25% of the eluted polymer is obtained and T₇₅ is the temperature in degrees Celsius at which 75% of the eluted polymer is obtained via temperature rising elution fractionation (TREF).

21. The shrink film of claim 1, wherein the shrink film has a haze of 15% or lower.

22. A process to produce a shrink film, the process comprising:
a) extruding a polyethylene polymer comprising at least 65 wt % ethylene derived units, based upon the total weight of the polymer, having:
i. a melt index (MI) from about 0.1 g/10 min to about 2.0 g/10 min;
ii. a density from about 0.905 g/cm³ to about 0.920 g/cm³; and
iii. a melt index ratio (MIR) from about 25 to about 80; to produce a molten material; and
b) blowing the molten material to produce a bubble to produce the shrink film having a total shrink of from 100% to 200%.

23. The process of claim 22, wherein the process is a single bubble extrusion process.

24. The process of claim 22, wherein the extruding occurs at a temperature of from 190° C. to 240° C.
